(19) United States
(12) Patent Application Publication
(10) Pub. No.: US 2019/0137050 A1
(43) Pub. Date: May 9, 2019

(54) INTERFACE CAP DESIGN FOR LIGHT TUBES

(71) Applicants: Dazhen WANG, Shaanxi (CN); Jinlin CAO, Shaanxi (CN); Rui JIAO, Shaanxi (CN); GE Lighting Solutions, LLC, East Cleveland, OH (US)

(72) Inventors: Dazhen WANG, Xi'an, Shaanxi (CN); Jinlin CAO, Xi'an, Shaanxi (CN); Jiao RUI, Xi'an, Shaanxi (CN)

(21) Appl. No.: 16/075,245

(22) PCT Filed: Feb. 15, 2016
(86) PCT No.: PCT/CN2016/073795

§ 371 Date: Aug. 3, 2018

(51) Int. Cl. F21K 9/272

(52) U.S. Cl. CPC F21K 9/272; F21Y 2115/10

(57) ABSTRACT

A new light apparatus (such as LED lamps) and lamp caps (30) for connecting the light apparatus to corresponding lighting fixtures for operation at higher voltages with existing lighting fixtures, by using modified caps (30) comprising groove/gap (32) patterns in the insulating materials of the caps (30). The new and/or improved lighting sources/light tubes operating at a higher voltage using the same interface caps (30) may require a larger minimum creepage distance between power coupling electrodes/pins (22a,22b). This can be accomplished by adding one or more grooves or gaps (32) of predefined dimensions in the electrically insulating materials on surface of cap (30) in a vicinity of the at least two conductive elements/electric pins (22a,22b). The light apparatus utilizing a same or a different lighting technology but operating at a higher operating voltage than the original/legacy light apparatus.

### TECHNICAL FIELD

The invention generally relates to lighting systems. More particularly but not exclusively, this invention relates to designing cap interface of lighting tubes for operation at higher voltages.

### BACKGROUND OF THE INVENTION

In recent years, a movement has gained traction to replace conventional light bulbs/lamps with lighting fixtures that employ more efficient lighting technologies including replacing relatively efficient fluorescent lighting fixtures with lighting technologies that produce a more pleasing, natural light. One such technology that shows tremendous promise employs light emitting diodes (LEDs). Compared with incandescent bulbs, LED-based light fixtures are much more efficient at converting electrical energy into light, are longer lasting, and are also capable of producing light that has a very natural-seeming spectral distribution of light frequencies or colors.

Compared with fluorescent lighting, LED-based fixtures are more efficient, and are capable of producing light that is much more natural and more capable of accurately rendering colors. Moreover, fluorescent light bulbs/fixtures have a theoretical long life span (some reports indicate approximately 10,000 hours), but failures occur much more frequently due to bulb and power supply issues. For example, the fluorescent bulbs require special ballast and starter devices that provide sufficient energy to create plasma within the bulb to cause it to glow. The high surges of current cause frequent failures of the ballast or starter devices. Replacement of these components usually requires disassembly of the cabinet or display case in which they are housed, which is particularly inconvenient and potentially hazardous when the fixture is ceiling-mounted, and the service person must climb a ladder to perform the service operation.

Although fluorescent bulbs can last approximately 10,000 hours, this is significantly shorter than the service life offered by current LED technology. Illumination sources that feature LEDs can withstand over 60,000 hours of continuous use. Moreover, LED sources are not as prone to failure due to on/off switching. The fluorescent light bulb requires an initial high current surge to start illumination. This surge is not needed in LED light sources.

As a result, lighting fixtures that employ LED technologies are expected to replace conventional and fluorescent bulbs/lamps in residential, commercial, and industrial applications.

### SUMMARY OF THE INVENTION

According to a first aspect of the invention, a light apparatus, comprising: at least one lamp cap comprising an electrically insulating material with at least two conductive elements embedded in the electrically insulating material and having one or more grooves of predefined dimensions in the electrically insulating material on a surface of the at least one lamp cap in a vicinity of the at least two conductive elements, wherein the light apparatus is configured to operate at a predefined voltage, so that the at least two conductive elements are also configured to operate at the predefined voltage, and a minimum creepage distance between the at least two conductive elements for the operation at the predefined voltage is provided by the one or more grooves. Further, the light apparatus may be configured to replace a previous light apparatus, and to operate at a higher predefined voltage than the previous light apparatus which requires a larger minimum creepage distance between the at least two conductive elements in the light apparatus than between at least two further conductive elements in the previous light apparatus, the larger minimum creepage distance between the at least two conductive elements being provided by the one or more grooves.

According to a second aspect of the invention, a lamp cap, of an light apparatus, comprising: at least one lamp cap comprising an electrically insulating material with at least two conductive elements embedded in the electrically insulating material and having one or more grooves of predefined dimensions in the electrically insulating material on a surface of the at least one lamp cap in a vicinity of the at least two conductive elements, wherein the light apparatus is configured to operate at a predefined voltage, so that the at least two conductive elements are also configured to operate at the predefined voltage, and a minimum creepage distance between the at least two conductive elements for the operation at the predefined voltage is provided by the one or more grooves. Further, at least one of the one or more grooves may comprise a gap or a hole which is cut through a thickness of the electrically insulating material in the at least one lamp cap.

### BRIEF DESCRIPTION OF THE DRAWINGS

These and other features and aspects of the present disclosure will become better understood when the following detailed description is read, with reference to the accompanying drawings, in which like characters represent like parts throughout the drawings, wherein:

FIG. 1A is an exemplary view of a conventional coupling of a conventional fluorescent lamp having a cap with two electrical pins to a corresponding fixture comprising a matching socket connected to a power supply;

FIG. 1B is an exemplary view of a plurality of conventional fluorescent lamps (shown in FIG. 1A) mounted on a dedicated fixture using two caps with two electrical pins on opposite sides of each lamp;

FIGS. 2A and 2B are exemplary views (FIG. 2A is a cross-sectional view and FIG. 2B is a top view) of a cap of a conventional light apparatus such as a fluorescent lamp;

FIGS. 3A and 3B are exemplary views (FIG. 3A is a cross-sectional view and FIG. 3B is a top view) of a cap of a light apparatus (such as LED) with a single groove to provide a minimum creepage distance between conductive elements/pins, according to an embodiment of the invention;

FIG. 4 is an exemplary view of a cap demonstrating another type of a groove pattern, according to an embodiment of the invention;

FIG. 5 is another exemplary view of a cap demonstrating a further type of a groove pattern, according to a further embodiment of the invention;

FIGS. 6A and 6B are views (a top view is shown in FIG. 6A and a three-dimensional view is shown in FIG. 6B) of a G5-based cap modified for the LED retrofitting application with a higher power voltage using a single symmetrical groove or a gap, according to an embodiment of the invention;

FIGS. 7A and 7B are views of a cap modified for the lamp application requiring/using a higher operating voltage (a top view is shown in FIG. 7A and a three-dimensional view is shown in FIG. 7B) using a single symmetrical gap, where the cap is not solid and has a small wall thicknesses, according to an embodiment of the invention;

FIGS. 8A and 8B 7B are views of a cap 80 modified for the lamp application requiring/using a higher operating voltage (a top view is shown in FIG. 8A and a three-dimensional view is shown in FIG. 8B) using two gaps between the pins, according to a further embodiment of the invention;

FIGS. 9A and 9B are views of a cap 90 modified for the lamp application requiring/using a higher operating voltage (a top view being shown in FIG. 9A and a three-dimensional view being shown in FIG. 9B) using a groove or a gap having a special shape (as shown in FIG. 4) according to a further embodiment of the invention;

FIGS. 10A and 10B are views of cap 100 modified for the lamp application requiring/using a higher operating voltage (a three-dimensional view being shown in FIG. 10A and another three-dimensional view of the cap shown in FIG. 10A being cross-sectionally cut, as shown in FIG. 10B), using a single symmetrical groove, where the cap is solid, according to yet another embodiment of the invention; and

FIGS. 11A and 11B are exemplary views of a LED lamp having two (on both ends) G5-like caps which are designed/modified according to various embodiments of the invention.

### DETAILED DESCRIPTION

A need exists for a reliable efficient light source/lamp such as LED-based, to retrofit/replace current conventional light sources including fluorescent lamps used in existing conventional light fixtures. Also, another need exists for using the various lamps with power fixtures providing higher voltage power based on a geographic location.

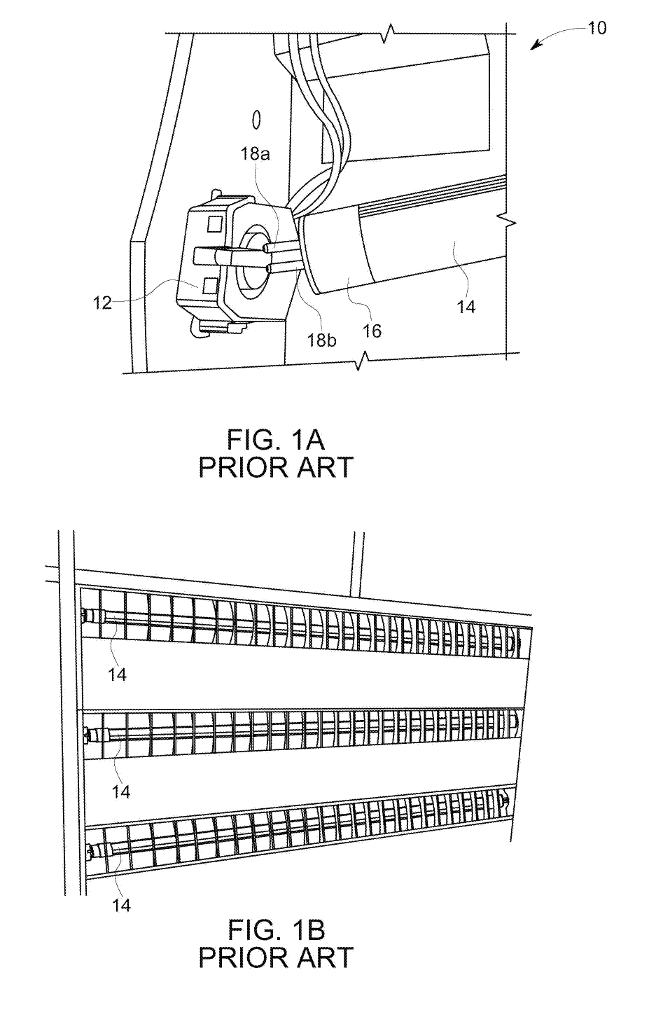

FIG. 1A is an exemplary view of a conventional coupling of a fluorescent lamp 14 with a cap 16 having two pins 18a and 18b for connecting to a corresponding fixture 12 comprising a matching socket connected to a power supply. FIG. 1B further demonstrates mounting a plurality of such fluorescent lamps 14 each using two caps 16 (on opposite sides of the lamp 14) to make corresponding electrical connections with a dedicated fixture.

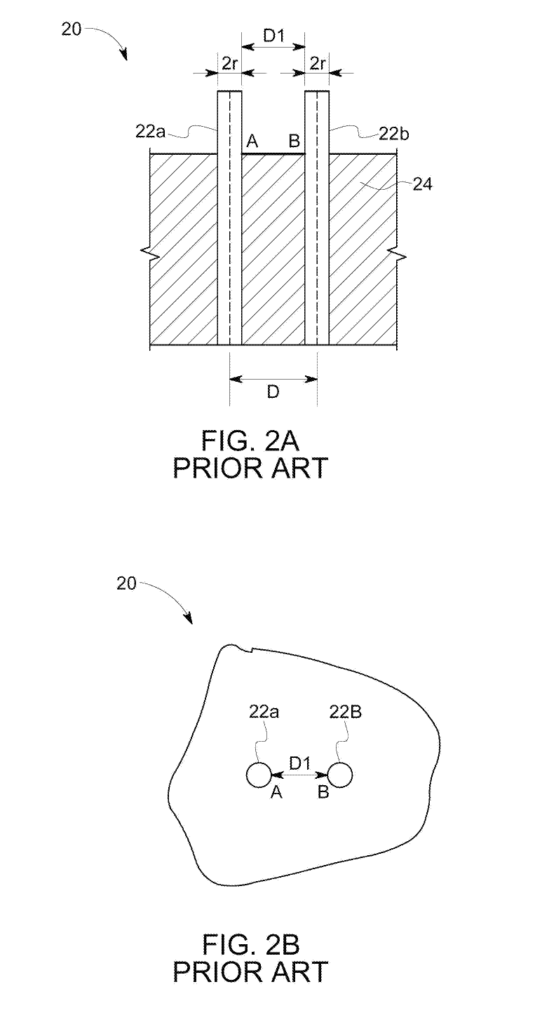

FIGS. 2A and 2B are exemplary views (FIG. 2A is a cross-sectional view and FIG. 2B is a top view) of a cap 20 of a conventional light apparatus, such as a fluorescent lamp or a LED lamp, comprising electrical pins 22a and 22b having a radius r (and a diameter 2r) embedded in an electrically insulating material 24 such as PBT (polybutylene terephthalate), PC (polycarbonate) materials or the like. A distance between parallel center axes of electrical pins 22a and 22b is D, and a shortest distance between pin's walls, i.e., between points A and B is D1. A critical parameter for implementing embodiments of the invention described herein, is a minimum creepage distance between conductive elements such as pins 22a and 22b.

A minimum creepage distance can be defined as the shortest path between two conductive parts (or between a conductive part and the bounding surface of the equipment) measured along the surface of the insulation. The document IEC 61347-1 2007 (IEC stands for “international electrotechnical committee”) on page 49, par. 16 provides a similar definition, stating that “Creepage distances are distances in air, measured along the external surface of the insulating material”. The creepage is usually a function of PTI (proof tracking index) sometimes called a comparative tracking index (CTI) of the insulating material, a function of a voltage used by and provided to the device/light apparatus, and a function of environmental conditions.

In FIGS. 2A and 2B this shortest creepage distance is between points A and B (distance D1). It is desirable, when replacing/retrofitting the legacy lamp 14 (shown in FIGS. 1A and 1B) with another and/or a more advanced light source/lamp operating at a higher voltage (power voltage), to use an interface cap (such as a cap 20 shown in FIGS. 2A and 2B) having similar matching electric pins 22a and 22b which are located at the same distance D from each other as in FIGS. 2a and 2b and to be configured for connection to a corresponding fixture like the fixture 12 shown in FIG. 1A. In other words, it is desirable, when replacing/retrofitting the lamp 14 with another light source/lamp operating at the higher voltage, to use a cap having similar matching pins to be connected to a corresponding fixture.

To accomplish this replacement/retrofitting, it is important to make sure that the replacement lamp would meet the minimum creeping distance requirement for replacing lighting lamp/light apparatus which is addressed by various embodiments of the invention as described herein.

New light apparatus (such as LED lamps) and caps (or lamp caps) for connecting the light apparatus to corresponding lighting fixtures are presented for operation at higher voltages with existing lighting fixtures, by using modified caps comprising groove/gap patterns in the insulating materials of the caps. The new and/or improved lighting sources/light tubes operating at a higher voltage using the same interface caps may require a larger minimum creepage distance between power coupling electrodes/pins. This can be accomplished by adding one or more grooves or gaps of predefined dimensions in the electrically insulating materials in a vicinity of the at least two conductive elements/electric pins. The embodiments disclosed herein are applicable to a light apparatus utilizing a same or a different lighting technology but operating at a higher operating voltage than the original/legacy light apparatus (e.g., in a different geographical area a different standard power voltage can be provided to the lighting fixture connected to the cap, or a novel light apparatus requires a higher operating voltage but can use the same cap).

Thus, according to one embodiment, a first light apparatus (e.g., LED lamp) utilizing a first lighting technology can be configured to replace a previous (legacy) light apparatus (e.g., fluorescent lamp) utilizing a previous lighting technology (which, in general, can be similar to, the same as or different from the first lighting technology) ; the light apparatus can comprise at least one lamp cap (e.g., a cap designed based on a standard G5 cap) containing an electrically insulating material (such as PBT, PC or similar insulating materials) with at least two conductive elements/pins embedded (typically in juxtaposed relationship with each other) in the electrically insulating material, and having one or more grooves/gaps/holes of predefined dimensions in a variety of shapes in the electrically insulating materials in a vicinity of and symmetrically or asymmetrically relative to the at least two conductive elements. The first light apparatus can be configured to be electrically connected to a fixture for receiving electrical power by using the at least two conductive elements (e.g., pins) of the cap, the same fixture can be originally designed for connection with at least two previous (legacy) conductive elements of the previous (legacy) light apparatus. Moreover, if the first light apparatus is configured to operate at a higher predefined voltage than the legacy light apparatus, this may require a larger minimum creepage distance between the at least two conductive elements than between the at least two legacy conductive elements in the legacy light apparatus. Then the larger minimum creepage distance between the at least two conductive elements can be provided by these one or more grooves/gaps/holes, according to various embodiments described herein.

It is noted that for the purposes of this invention, a term “groove”, if used alone, may be broadly interpreted as a groove having a finite depth in the electrically insulating material or being a groove through a total thickness of the electrically insulating material (such as a gap or a hole).

According to one embodiment, the at least two conductive elements and the at least two legacy conductive elements may be identically connected to the fixture. For example, distances between the at least two conductive elements and the at least two legacy conductive elements may be equal. According to another embodiment, the electrical insulating material in the cap can be PBT (polybutylene terephthalate) material, PC (polycarbonate) material or the like, as discussed above.

According to a further embodiment, if the retrofitting/replacing light apparatus requires a higher operating voltage, a determination can be made, whether an insulating material with higher voltage rating for the corresponding value of PTI/CTI (defined above) may be needed. Table 1 below shows operating voltage ranges and corresponding UL card values for an insulating material under consideration.

TABLE 1
CTI (PTI) values as a function of operating voltage.

| CTI | |
|---|---|
| Voltage | CTI parameter (from |
| range(V) | UL card) |
| >600 | 0 |
| 400-599 | 1 |
| 250-399 | 2 |
| 175-249 | 3 |
| 100-174 | 4 |
| <100 | 5 |

Thus, depending on the desired operating voltage of the advanced light apparatus, an appropriate insulating material can be chosen. For example, if the projected device operating voltage range is between 175 and 249 V, an insulating material with the UL card value of 3 can be chosen such as PC LEXAN, PC EMERGE and the like. For the projected device operating voltage range between 250 and 399V, an insulating material with the UL card value of 2 can be chosen such as PC PENLITE or the like.

After choosing the insulating material, it can be further determined whether a larger minimum creepage distance between the at least two conductive elements/pins is needed. If it is determined, using Table 2 (from the international standard document IEC 60061-4, sheet 7007-6-2), that, for example, the minimum creepage distance D1 between the pins 22a and 22b (see FIG. 2A and 2B) is less than a corresponding value in Table 2, then further application of the grooves/gap technique to reach the required minimum creepage distance value can be used as described in exemplary embodiments below.

TABLE 2
Minimum distances for a.c. (50 Hz/60 Hz) sinusoidal voltages.

| | Operating voltage range (r.m.s) in Volts | | | | | |
|---|---|---|---|---|---|---|
| | 0-50 | 50-150 | 150-250 | 250-500 | 500-750 | 750-1000 |
| Creepage | | | | | | |
| distances (mm) | | | | | | |
| Materials with | | | | | | |
| PTI: | | | | | | |
| >600¹⁾ | 0.6 | 1.4 | 1.7 | 3 | 4 | 5.5 |
| <600¹⁾ | 1.2 | 1.6 | 2.5 | 5 | 8 | 10 |
| Clearances | 0.2 | 1.4 | 1.7 | 3 | 4 | 5.5 |
| (mm) | | | | | | |

¹⁾PTI (Proof Tracking Index) in accordance with IEC 60112

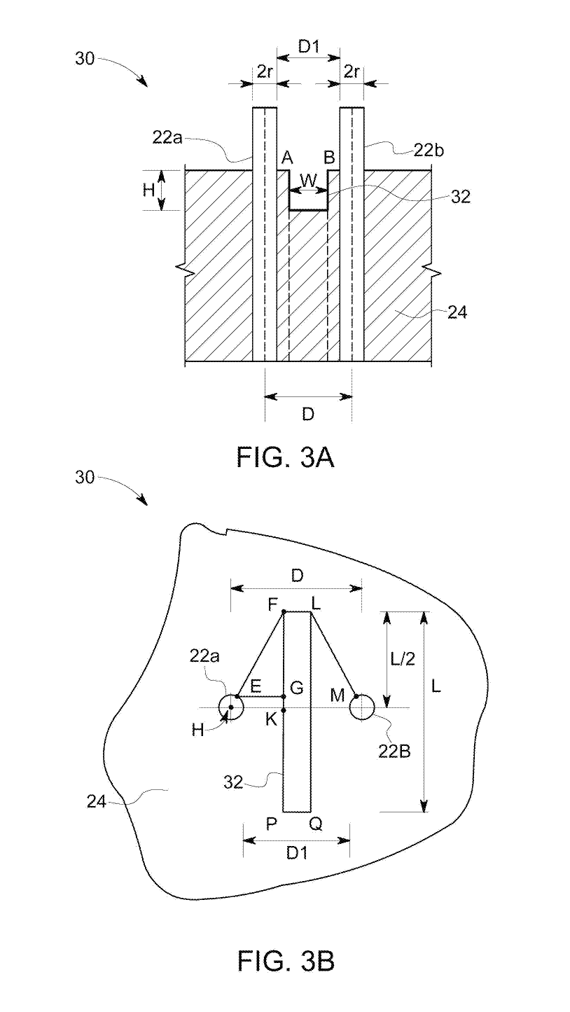

FIGS. 3-11 are demonstrations of non-limiting exemplary embodiments using various groove patterns for meeting requirements for the minimum creepage distances between at least two conductive elements such as pins 22a and 22b with similar dimensions (r, D and D1) as shown in FIGS. 2A and 2B. For clarity, identical/similar components in these figures are assigned the same reference numbers.

FIGS. 3A and 3B are non-limiting exemplary views (FIG. 3A is a cross-sectional view and FIG. 3B is a top view) of a lamp cap 30 of an advanced light apparatus (such as LED lamp) comprising electrical pins 22a and 22b (as in FIGS. 2A and 2B) having a radius r (diameter 2r) embedded in an electrically insulating material 24 such as PBT, PC or the like, electrical pins 22a and 22b protruding from the electrically insulating material 24. Similar to FIGS. 2A and 2B, a distance between parallel center axes of electrical pins 22a and 22b is D, and a shortest distance between pin's walls, i.e., between points A and B is D1 as shown in FIG. 3A. In this case, a required minimum creepage, Dₘᵢₙ, distance between conductive elements/pins 22a and 22b may be larger than the distance D1 between the points A and B which can be remedied by using a single groove 32 symmetrically located between the pins 22a and 22b with a height H, a width W and a length L. It is noted that, in general, the symmetrical location of the groove 32 is not required, so that different asymmetric locations of the groove 32 relative to the pins 22a and 22b can be practiced as well. The following restrictions for the dimensions of the groove 32 can be formulated.

From FIG. 3A, it follows that a minimum height Hₘᵢₙ of the groove 32 can be found as a half of a difference (D1−Dₘᵢₙ ), where Dₘᵢₙ the required minimum creepage distance, can be ascertained from Table 2 based on operating voltage and PTI values. For example, for the operating voltage range of 150-250 V and PTI of less than 600, Dₘᵢₙ=2.5 mm.

Then the maximum height H is only limited by a thickness T of the cap 30, i.e., the groove 32 can be a gap or a hole all the way through the thickness of the cap 30. Therefore, a general expression for the height H of a single symmetrical groove 32 having a finite depth between the two conductive elements/pins can be written as follows:

T>H≥½(Dₘᵢₙ−D1) (1).

Moreover, the width W of the groove 32 can be limited by the dimension D1 (W<D1) and also should be equal to 1 mm or more based on a standard requirement “The contribution to the creepage distance of any groove less than 1 mm wide shall be limited to its width” (e.g., see international standard document IEC 61347-1, Second Edition 2007-1, page 49, paragraph 16 “Creepage distances and clearances”). Therefore, a general expression for the width W of a single symmetrical groove 32 between the two conductive elements/pins can be written as follows:

D1>W≥1 mm (2).

Furthermore, FIG. 3B demonstrates a background for calculation/limitation of a length L of the groove 32. The minimum creepage distance Lₘᵢₙ (from the pin 22a to the pin 22b) on a surface of the cap 30 can be calculated as a path EFLM. From geometry shown in FIG. 3B, a distance HF can be used to form two equations:

Dₘᵢₙ=2HF+W−2r (3a) and

HF²=(Lₘᵢₙ/2)²+(D/2−W/2)² (3b),

where r, W, D and Dₘᵢₙ are defined above.

By solving Equations 3a and 3b together (e.g., substituting HF from Equation 3a into Equation 3b), a solution for the Lₘᵢₙ can be written as follows:

Lₘᵢₙ=\sqrt{(W+2r)²+(D−W)²} (4),

so that a general expression for the length L of a single symmetrical groove 32 between the two conductive elements/pins can be written as follows:

L≥\sqrt{(W+2r)²+(D−W)²} (5).

For example, for the standard G5-based cap used for LED application, the following parameters can be applied: Dₘᵢₙ=2.5 mm (see Table 2), 2r=2.79 mm, D=4.75 mm, D1=1.96 mm, and W=1 mm (see Equation 2). Then, using Equations 1 and 5, the calculated dimensions of the groove can be found to be H≥0.27 mm and L≥2.8 mm. It is further noted, that similar limitations for H, W and L can be determined for asymmetric locations of the groove 32 relative to the pins 22a and 22b using similar methodology, as described above. For example, the Equationl for the depth H can be used for asymmetric location of a single groove.

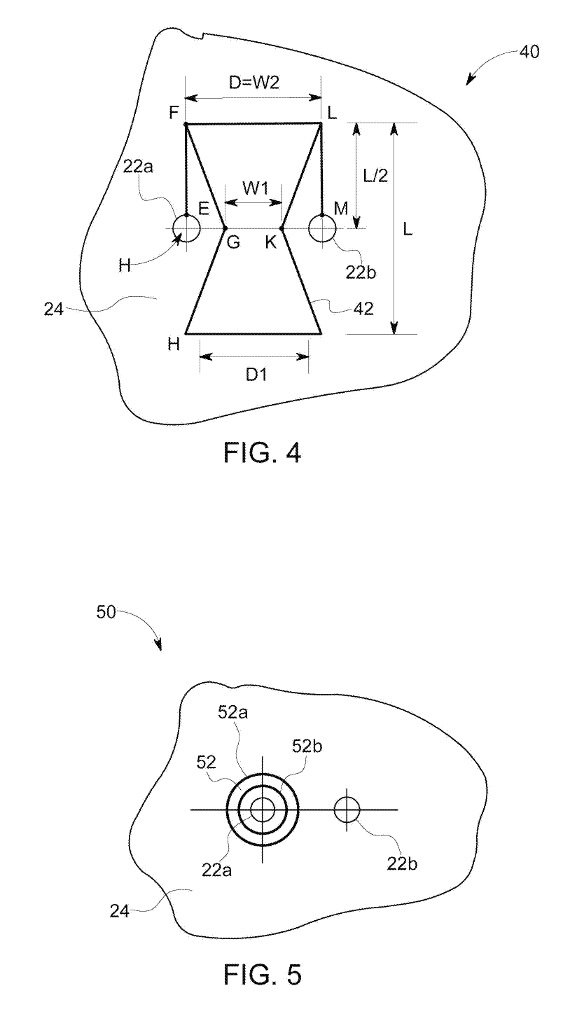

FIGS. 4 and 5 are non-limiting exemplary views demonstrating different types of groove patterns, according to various embodiments of the invention. FIG. 4 shows a groove 42 encompassing an area GFLKPN (having two widths W₁ and W₂, and a length L) on a surface of the cap 40, symmetrical relative to the pins 22a and 22b. The minimum creepage distance Lₘᵢₙ (from the pin 22a to the pin 22b) on a surface of the cap 40 can be calculated as a path EFLM. From geometry shown in FIG. 4, it follows that W₂=D, and Lₘᵢₙ=2L+D−2r. Thus, the groove dimension limitations in this case can be expressed for one option as follows: W₁≥1 mm, W₂=D, and L≥2L+D−2r. It is further noted that the symmetrical location of the groove 42 is not required, so that different asymmetric locations of the groove 42 relative to the pins 22a and 22b can be practiced as well. Also a shape of the groove 42 is non-limiting, so that many other shapes can be used according to further embodiment of the invention.

FIG. 5 is another non-limiting example demonstrating a further groove pattern, according to a further embodiment of the invention. In FIG. 5, a grove 52, having a round pattern with edges 52a and 52b can completely surround one of the electrical pins 22a and 22b (for example, the pin 22a being surrounded, as shown in FIG. 5). The only relevant parameter of the groove 52 then is a height H of the groove, which can be estimated using Equation (1) as follows T>H≥½(Dₘᵢₙ−D1).

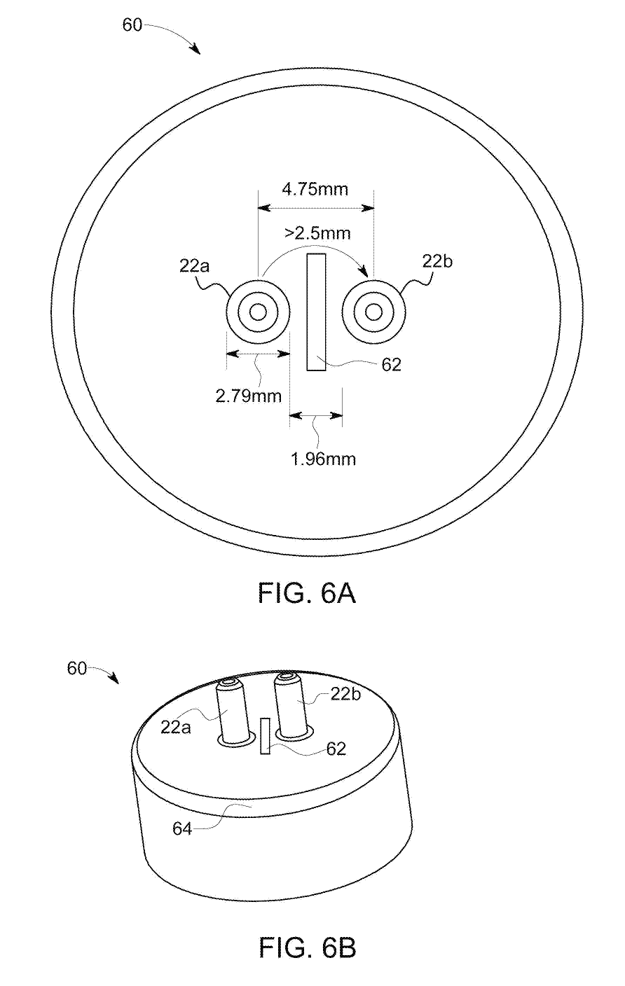

FIGS. 6A and 6B are views (a top view is shown in FIG. 6A and a 3-dimensional view is shown in FIG. 6B) of a G5-based light cap 60 modified for the LED retrofitting application using a single symmetrical groove or a gap 62 (i.e., the gap can be defined as a hole all the way through the thickness of the insulating material of the cap 60) between the conducting elements (electrical pins) 22a and 22b imbedded in the insulating material 64, according to an embodiment of the invention.

Traditionally, G5 cap is a normal cap for a LFL (linier fluorescent) T5 tube.). LED T5 tube for CE (European conformity) certification to replace the LFL T5 tube, according to IES 62776 requirement, can be designed/re-designed in order to achieve a minimum creepage distance requirement. A corresponding light cap for the LED T5 tube or for a corresponding OLED (organic LED) can be based on a standard G-5 light cap having a similar structure and/or functionality as the standard G-5 cap, as described herein.

For example, the voltage of the T5 tube in some countries can be high, e.g., 220-240V. From Table 2 it follows that the minimum creepage distance for voltages below 250V should be eaqal or larger than 2.5 mm. However, the minimum distance D1 of the normal G5 cap is just 1.96 mm. The gap 62 is added symmetrically between the pins 22a and 22b, as shown in FIGS. 6A and 6B to remedy this problem. Then the minimum creepage distance should bypass the gap as shown in FIG. 6A. So the minimum creepage distance can be longer than before, e.g., can be equal or exceed 2.5 mm, meanwhile the width of the gap (still limited by the smallest value of one mm) will not impact the creepage distance. The boundaries/mathematical expressions for defining length and width of the gap 62 (see FIGS. 3A and 3B) can be determined using Equations 2 and 5.

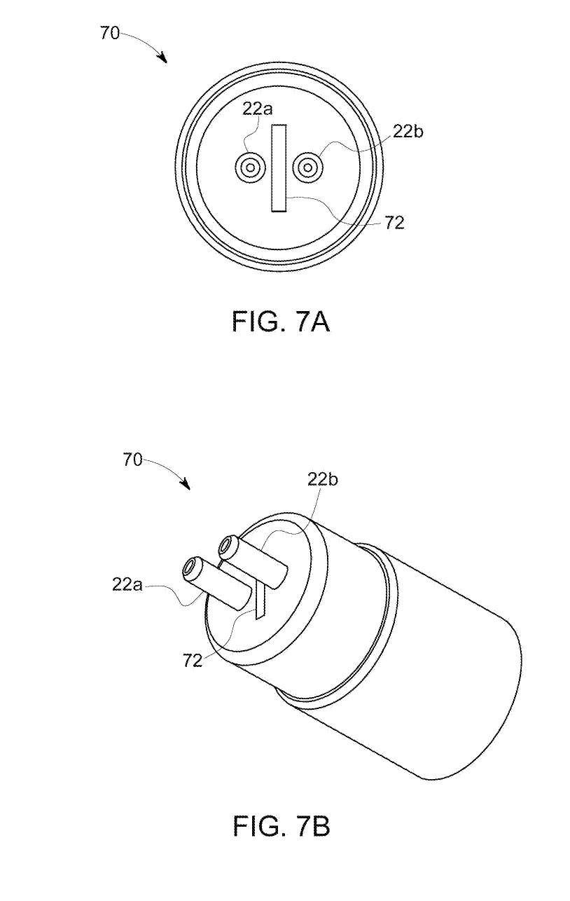

FIGS. 7-11 further demonstrate various non-limiting implementation examples using embodiments described herein. FIGS. 7A and 7B show a cap 70 modified for an application requiring/using a higher operating voltage (e.g., for example, the LED lamp application with a top view in FIG. 7A and a three-dimensional view in FIG. 7B. The cap 70 is not solid with a small wall thicknesses (not shown in FIGS. 7A and 7B) and has one gap 72 between the pins 22a and 22b.

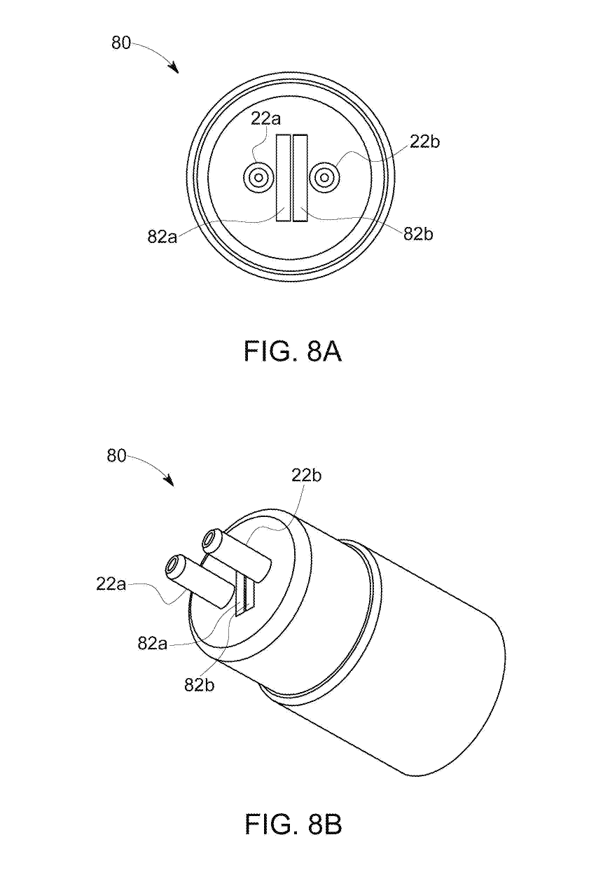

FIGS. 8A and 8B show a cap 80 modified for the lamp application requiring/using a higher operating voltage (top view in FIG. 8A and a three-dimensional view in FIG. 8B). The cap 80 is also not solid with a small wall thicknesses (not shown in FIGS. 8A and 8B) and comprises two grooves/gaps 82a and 82b side-by-side (parallel to each other) between the pins 22a and 22b. The gaps/grooves 82a and 82b can have the same size or may be different. Also the gaps/grooves 82a and 82b may be symmetrical or asymmetrical relative to the pins 22a and 22b. The widths of the groves 82a and 82b can be differ as well. Moreover, a number of grooves, similar to grooves 82a and 82b cab also more than two.

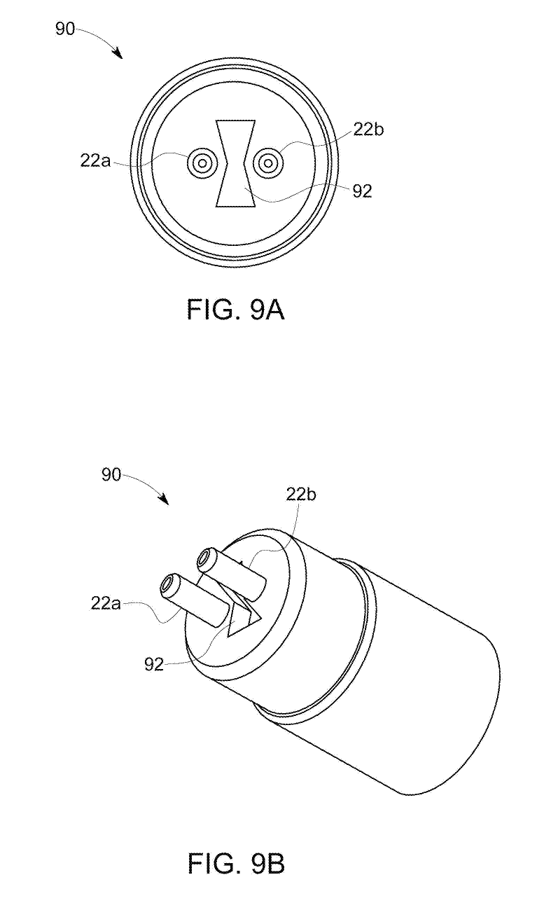

FIGS. 9A and 9B show a cap 90 modified for the lamp application requiring/using a higher operating voltage (a top view in FIG. 9A and a three-dimensional view in FIG. 9B). The cap 90 can be solid, or it can be not solid with a small wall thicknesses (not shown in FIGS. 9A and 9B) and can have a groove or a gap having a special shape (as shown in FIG. 4) between the pins 22a and 22b, as described herein.

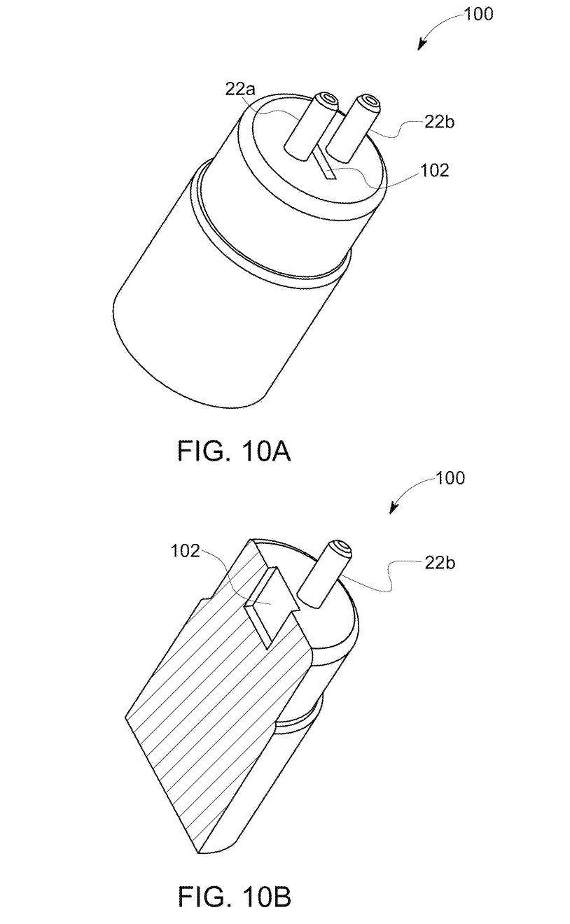

FIGS. 10A and 10B show a cap 70 modified for the lamp (e.g., LED lamp) application requiring/using a higher operating voltage (a three-dimensional view is shown in FIG. 10A and another three-dimensional view of FIG. 10A being cross-sectionally cut is shown in FIG. 10B). In this case the cap 100 is solid and configured to have one groove 102 between the pins 22a and 22b. The boundaries/mathematical expressions for defining length, depth and width of the groove 102 (see FIGS. 3A and 3B) can be provided using Equations 1, 2 and 5.

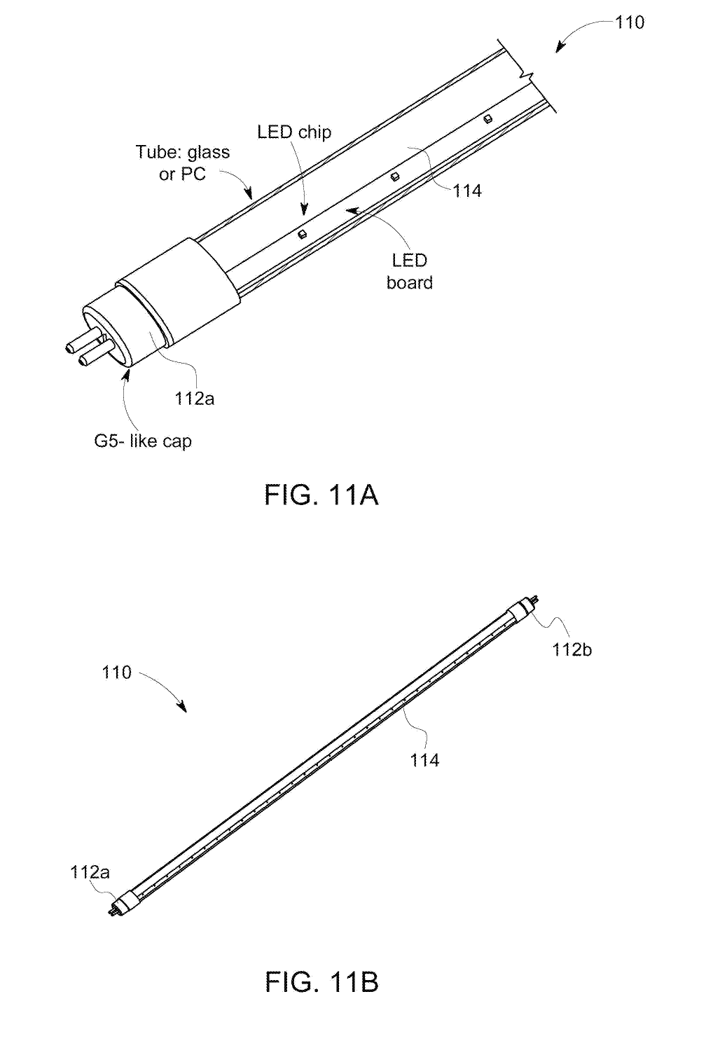

Finally, FIGS. 11A and 11B are exemplary views of a LED lamp 114 having two (on both ends) G5-like caps 112a and 112b designed/modified according to various embodiments of the invention, so that the LED lamp 114 can be used for substituting, retrofitting or replacing using a corresponding legacy fixture 12 shown in FIG. 1A respectively.

Unless defined otherwise, technical and scientific terms used herein have the same meaning as is commonly understood by one having ordinary skill in the art to which this disclosure belongs. The terms “first”, “second”, and the like, as used herein, do not denote any order, quantity, or importance, but rather are employed to distinguish one element from another. Also, the terms “a” and “an” do not denote a limitation of quantity, but rather denote the presence of at least one of the referenced items. The use of “including,” “comprising” or “having” and variations thereof herein are meant to encompass the items listed thereafter and equivalents thereof, as well as additional items. The terms “connected” and “coupled” are not restricted to physical or mechanical connections or couplings, and can include electrical and optical connections or couplings, whether direct or indirect.

Furthermore, the skilled artisan will recognize the interchangeability of various features from different embodiments. The various features described, as well as other known equivalents for each feature, can be mixed and matched by one of ordinary skill in this art, to construct additional systems and techniques in accordance with principles of this disclosure.

In describing alternate embodiments of the light apparatus claimed, specific terminology is employed for the sake of clarity. The invention, however, is not intended to be limited to the specific terminology so selected. Thus, it is to be understood that each specific element includes all technical equivalents that operate in a similar manner to accomplish similar functions.

It is to be understood that the foregoing description is intended to illustrate and not to limit the scope of the invention, which is defined by the scope of the appended claims. Other embodiments are within the scope of the following claims.

It is noted that various non-limiting embodiments described and claimed herein may be used separately, combined or selectively combined for specific applications.

Further, some of the various features of the above non-limiting embodiments may be used to advantage, without the corresponding use of other described features. The foregoing description should therefore be considered as merely illustrative of the principles, teachings and exemplary embodiments of this invention, and not in limitation thereof.

1. A light apparatus, comprising:
at least one lamp cap comprising an electrically insulating material with at least two conductive elements embedded in the electrically insulating material and having one or more grooves of predefined dimensions in the electrically insulating material on a surface of the at least one lamp cap in a vicinity of the at least two conductive elements,
wherein the light apparatus is configured to operate at a predefined voltage, so that the at least two conductive elements are also configured to operate at the predefined voltage, and a minimum creepage distance between the at least two conductive elements for the operation at the predefined voltage is provided by the one or more grooves.

2. The light apparatus of claim 1, wherein the light apparatus is configured to replace a previous light apparatus, and to operate at a higher predefined voltage than the previous light apparatus which requires a larger minimum creepage distance between the at least two conductive elements in the light apparatus than between at least two further conductive elements in the previous light apparatus, the larger minimum creepage distance between the at least two conductive elements being provided by the one or more grooves.

3. The light apparatus of claim 2, wherein the light apparatus and the previous light apparatus use a same lighting technology.

4. The light apparatus of claim 2, wherein the light apparatus and the previous light apparatus use different lighting technologies.

5. The light apparatus of claim 2, wherein the light apparatus is configured to be electrically connected to a fixture for receiving electrical power by using the at least two conductive elements, the fixture being originally designed for connection with at least two further conductive elements of the previous light apparatus.

6. The light apparatus of claim 2, wherein at least one of the one or more grooves comprises a gap or a hole which is cut through a thickness of the electrically insulating material in the at least one lamp cap.

7. The light apparatus of claim 2, wherein the light apparatus comprises a light emitting diode (LED) lamp or an organic light emitting diode (OLED) lamp.

8. The light apparatus of claim 2, wherein distances between the at least two conductive elements and the at least two further conductive elements are equal.

9. The light apparatus of claim 1, wherein the one or more grooves comprise one groove located between the at least two conductive elements.

10. The light apparatus of claim 1, wherein the one or more grooves comprise two grooves located between the at least two conductive elements.

11. The light apparatus of claim 1, wherein the one or more grooves comprise one groove around at least one of the at least two conductive elements.

12. The light apparatus of claim 1, wherein the at least two conductive elements are electric pins protruding from one surface of the at least one lamp cap.

13. The light apparatus of claim 1, wherein the at least two conductive elements are in juxtaposed relationship.

14. The light apparatus of claim 1, wherein the one or more grooves comprise one groove located between the at least two conductive elements, and a depth of the one groove is equal or exceeds a half of a difference between the minimum creepage distance between the at least two conductive elements for the light apparatus to operate at the predefined voltage and a shortest distance between walls of the at least two conducting elements at the surface of the at least one lamp cap.

15. The light apparatus of claim 1, wherein the light cap is designed based on a standard G5 cap.

16. The light apparatus of claim 1, wherein an insulation proof tracking index of the electrically insulating material is less than 600.

17. The light apparatus of claim 1, wherein a minimum width of each of the one or more grooves on the surface of the at least one lamp cap is one millimeter or more.

18. The light apparatus of claim 1, wherein the electrically insulating material comprises a polybutylene terephthalate (PBT) material or a polycarbonate (PC) materials.

19. A lamp cap of an light apparatus, the cap comprising:
at least one lamp cap comprising an electrically insulating material with at least two conductive elements embedded in the electrically insulating material and having one or more grooves of predefined dimensions in the electrically insulating material on a surface of the at least one lamp cap in a vicinity of the at least two conductive elements,
wherein the light apparatus is configured to operate at a predefined voltage, so that the at least two conductive elements are also configured to operate at the predefined voltage, and a minimum creepage distance between the at least two conductive elements for the operation at the predefined voltage is provided by the one or more grooves.

20. The lamp cap of claim 19, wherein at least one of the one or more grooves comprises a gap or a hole which is cut through a thickness of the electrically insulating material in the at least one lamp cap.
